(19) United States
(12) Patent Application Publication
(10) Pub. No.: US 2025/0018694 A1
(43) Pub. Date: Jan. 16, 2025

(54) FILM, LAMINATED FILM, RIGID ARTICLE, PACKAGE, AND METHOD OF MAKING FILM

(71) Applicant: AMCOR FLEXIBLES NORTH AMERICA, INC., Neenah, WI (US)

(72) Inventors: Marcelo B. ELIAS, Appleton, WI (US); Otacilio T. BERBERT, Oshkosh, WI (US); Daniel C. MILLER, Appleton, WI (US)

(21) Appl. No.: 18/711,854

(22) PCT Filed: Nov. 22, 2021
(86) PCT No.: PCT/US2021/060383

§ 371 Date: May 20, 2024

(51) Int. Cl. B32B 27/08; B32B 7/12; B32B 27/18; B32B 27/30; B32B 27/32; B32B 27/34; B32B 27/36

(52) U.S. Cl. CPC B32B 27/08; B32B 7/12; B32B 27/18; B32B 27/306; B32B 27/32; B32B 27/34; B32B 27/36; B32B 2250/24; B32B 2255/10; B32B 2255/20; B32B 2272/00; B32B 2307/514; B32B 2439/00

(57) ABSTRACT

A film includes a matrix phase including polyethylene in the amount of 75% to 99.5% by weight of the film. The film further includes a dispersion phase including polyester in the amount of 0.5% to 25% by weight of the film. The dispersion phase includes droplets. 90% of the droplets include an average length of 0.2 microns to 5.0 microns. The droplets are dispersed in the matrix phase.

### TECHNICAL FIELD

The present application relates generally to a film, a laminated film, a rigid article, a package including the film and/or the laminated film, and a method of making the film.

### BACKGROUND

Various types of films used for packaging are known in the art. Global demand for plastic waste reduction and sustainable packaging solutions is on the rise. Recycling is often efficient or may only be possible if the materials in the package are of the same polymer because combinations of incompatible materials in a packaging film can create difficulties when recycling the packaging film.

One example of packaging films includes a laminated film structure of PET/PE. There is a trend of replacing films that contain polyester (PET) with more recyclable options, such as films made entirely of polyethylene (PE). However, PET may provide unique physical and cost-effective properties to the films that may not be provided solely by PE. Although, PET is considered as a stream contaminant in a PE recycling stream. The PET may be strongly bonded to the PE in such packaging films that a chemical separation process is used to separate PET from PE. The chemical separation process may be complicated and is under development.

Furthermore, during recycling of such PET/PE packaging films, PET and PE are often incompatible with each other due to their different melting points. As a result, during recycling of such PET/PE packaging films, a high processing temperature is used for melting PET that may degrade PE, or a low processing temperature is used for melting PE that does not melt the PET where either situation may further clog filters of recycling equipment. In other circumstances, the packaging film is destined for landfills or incineration facilities because of the challenges with processing these incompatible polymers.

### SUMMARY

A film has been developed that includes micronized polyester. The film may allow reuse of polyester-containing waste. Specifically, the film may allow reuse of polyester-containing films, whether post-industrial recycled (PIR) and/or post-consumer recycled (PCR). Furthermore, the film may have improved stiffness due to a presence of polyester in the film and may allow use of less material (downgauging) for packaging purposes.

One embodiment of the present disclosure is a film. The film may include a matrix phase including polyethylene in the amount of 75% to 99.5% by weight of the film. The film may further include a dispersion phase including polyester in the amount of 0.5% to 25% by weight of the film. The dispersion phase may include droplets. 90% of the droplets may include an average length of 0.2 microns to 5.0 microns. The droplets are dispersed in the matrix phase.

The film may include micronized polyester in form of the droplets dispersed in the matrix phase including polyethylene. Use of polyester in the film may allow reuse of polyester-containing waste, which is generally disposed of in landfills and incineration facilities. As a result, the film may be sustainable due to use of a recycled material (i.e., recycled polyester-containing waste). Furthermore, the film may have increased stiffness due to the micronized polyester, which may further allow use of less material (downgauging) for packaging purposes.

The film including the micronized polyester may be made without using a complicated chemical separation process. The film may be made by recycling a PET/PE structure without use of compatibilizers in order to promote micronization of the PET of the PET/PE structure. The compatibilizers may be optionally added during extrusion of the film after the micronization of the PET. Accordingly, the film may be environmentally and economically friendly.

In some embodiments, the film is a coextruded film.

In some embodiments, the film is a multilayer film.

In some embodiments, the polyethylene may include ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.

In some embodiments, the polyester may include a melting point from 250° C. to 290° C.

In some embodiments, the film may further include a compatibilizer.

In some embodiments, the polyester may include post-industrial recycled (PIR) polyester or post-consumer recycled (PCR) polyester.

Another embodiment of the present disclosure may include a laminated film. The laminated film may include the film. The laminated film may further include a second film laminated to the film. The film may include an exposed surface of the laminated film.

In some embodiments, the laminated film may further include a substrate. The substrate may include oriented polyester, oriented nylon, or oriented polypropylene.

Another embodiment of the present disclosure may include a package including the film or the laminated film.

Another embodiment of the present disclosure may include a laminated film. The laminated film may include a first film including a first layer, a second layer, and a third layer with each layer including a first surface and an opposing second surface. The laminated film may further include a second film. The first layer and the third layer may include polyethylene. The second layer may include a matrix phase including polyethylene in the amount of 75% to 99.5% by weight of the first film and a dispersion phase including polyester in the amount of 0.5% to 25% by weight of the first film. The dispersion phase may include droplets. 90% of the droplets may include an average length of 0.2 microns to 5.0 microns. The droplets are dispersed in the matrix phase. The first layer, the second layer, and the third layer are coextruded with each other and positioned relative to each other in a sequential order. The second film is laminated to the first film and includes an exposed surface of the laminated film.

In some embodiments, the second film is oriented.

In some embodiments, the second film and the first film are laminated by heat, extrusion, or adhesive.

In some embodiments, the laminated film may further include printed indicia.

In some embodiments, the polyethylene of the first, second, and third layers includes ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.

Another embodiment of the present disclosure is a package including the laminated film.

Another embodiment of the present disclosure is a film. The film may include a matrix phase including polyolefin in the amount of 75% to 99.5% by weight of the film. The film may further include a dispersion phase including a chemically incompatible-to-PE polymer in the amount of 0.5% to 25% by weight of the film. The dispersion phase may include droplets. 90% of the droplets may include an average length of 0.2 microns to 5.0 microns. The droplets are dispersed in the matrix phase.

In some embodiments, the matrix phase includes polyethylene, polypropylene, or combinations thereof.

Another embodiment of the present disclosure is a rigid article. The rigid article may include a matrix phase including polyethylene in the amount of 75% to 99.5% by weight of the rigid article. The rigid article may further include a dispersion phase including polyester in the amount of 0.5% to 25% by weight of the rigid article. The dispersion phase includes droplets. 90% of the droplets may include an average length of 0.2 microns to 5.0 microns. The droplets are dispersed in the matrix phase.

Another embodiment of the present disclosure is a method of making a film. The method may include obtaining a polyethylene film including from 10% to 15% of a chemically incompatible-to-PE polymer and 85% to 90% polyethylene by weight. The method may further include utilizing a continuous melt filtration pelletizer including a filter including a plurality of apertures from 5 microns to 150 microns within a temperature range above a melting point of the polyethylene and at least 5% below a melting point of the chemically incompatible-to-PE polymer. The method may further include maintaining the continuous melt filtration pelletizer at a pressure below 112 megapascals (MPa). The method may further include forming a plurality of pellets. Each pellet may include a dispersed phase including the chemically incompatible-to-PE polymer in the amount of less than 25% by weight of the pellet. The dispersed phase may include droplets including an average length from 0.2 microns to 5.0 microns. The method may further include melting the pellets in an extrusion process. The method may further include forming a film that includes a matrix phase including polyethylene in the amount of 75% to 99.5% by weight of the film and a dispersion phase comprising the chemically incompatible-to-PE polymer in the amount of 0.5% to 25% by weight of the film. The dispersion phase may include droplets. 90% of the droplets may include an average length of 0.2 microns to 5.0 microns. The droplets are dispersed in the matrix phase.

The plurality of pellets may be formed without use of compatibilizers in order to promote micronization of the chemically incompatible-to-PE polymer of the polyethylene film. The compatibilizers may be optionally added at the extrusion process.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic cross-sectional view of a film in accordance with an embodiment of the present disclosure;

FIG. 2 is a schematic cross-sectional view of a laminated film in accordance with an embodiment of the present disclosure;

FIG. 3 is a schematic cross-sectional view of a first film in accordance with an embodiment of the present disclosure;

FIG. 4A is a schematic cross-sectional view of a laminated film in accordance with an embodiment of the present disclosure;

FIG. 4B is a schematic top view of the laminated film of FIG. 4A;

FIG. 5 is a schematic perspective view of a package in accordance with an embodiment of the present disclosure;

FIG. 6 is a schematic cross-sectional view of a rigid article in accordance with an embodiment of the present disclosure;

FIGS. 7A-7D illustrate various steps of filtration and micronization of a polyethylene film using a continuous melt filtration pelletizer in accordance with an embodiment of the present disclosure;

FIG. 7E is a schematic view of a plurality of pellets in accordance with an embodiment of the present disclosure;

FIG. 8 is a flowchart depicting steps of a method of making a film in accordance with an embodiment of the present disclosure;

FIG. 9 is a scanning electron microscope (SEM) photograph of a first pellet; and

FIG. 10 is a SEM photograph of a second pellet.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a film. The film includes a matrix phase including polyethylene in the amount of 75% to 99.5% by weight of the film. The film further includes a dispersion phase including polyester in the amount of 0.5% to 25% by weight of the film. The dispersion phase includes droplets. 90% of the droplets include an average length of 0.2 microns to 5.0 microns. The droplets are dispersed in the matrix phase.

The film may include micronized polyester in the form of the droplets dispersed in the matrix phase including polyethylene. Use of polyester in the film may allow reuse of polyester-containing waste, which is generally disposed of in landfills and incineration facilities. As a result, the film may be sustainable due to use of a recycled material (i.e., recycled polyester-containing waste). Furthermore, the film may have increased stiffness due to the micronized polyester, which may further allow use of less material (downgauging).

The film including the micronized polyester may be made without using a complicated chemical separation process. The film may be made by recycling a PET/PE structure (i.e., laminated structure) without use of compatibilizers in order to promote micronization of the PET of the PET/PE structure. The compatibilizers may be optionally added during extrusion of the film after the micronization of the PET. Therefore, the film may be environmentally and economically friendly.

As used herein, the term “film” is a material with a very high ratio of a length or a width to a thickness. A film has two major surfaces defined by a length and a width. Films typically have good flexibility and can be used for a wide variety of applications, including flexible packaging. Films may also be of thickness and/or material composition such that they are flexible, semi-rigid, or rigid (i.e., a high amount of bendability, a limited amount of bendability, or little to no bendability, respectively). Films may be described as monolayer or multilayer.

As used herein, the term “layer” refers to a thickness of material that may be homogeneous or heterogenous. Layers may be of any type of material including polymeric, cellulosic, and metallic, or a blend thereof. A given polymeric layer may consist of a single polymer-type or a blend of polymers and may be accompanied by additives. In some cases, a layer may include a matrix phase and a dispersion phase dispersed in the matrix phase. The matrix phase may include a first polymer and the dispersion phase may include a second polymer different from the first polymer. A given layer may be combined or connected to other layers to form films. A layer may be either partially or fully continuous as compared to adjacent layers or the film. A given layer may be partially or fully coextensive with adjacent layers. A layer may contain sub-layers.

As used herein, the terms “interior” and “exterior” refer to the major surfaces of a film or a layer, and to the location in reference to the use of the film or the layer in a package configuration. Interior films or layers may comprise an innermost major surface in the package configuration. Exterior films or layers may comprise an outermost major surface in the package configuration.

As used herein, the term “adhesive layer” refers to a layer which has a primary function of bonding two adjacent layers together. The adhesive layers may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material.

As used herein, the term “sealing film” refers to a film, sheet, etc., involved in the sealing of the film, sheet, etc., to itself and/or to another layer of the same or another film, sheet, etc.

As used herein, the term “barrier” refers to any material which controls a permeable element of a film, sheet, web, package, etc., against aggressive agents, and includes, but is not limited to, oxygen barrier, moisture (e.g., water, humidity, etc.) barrier, chemical barrier, heat barrier, light barrier, and odor barrier. The term “barrier layer” refers to a layer of the film, sheet, web, package, etc., which controls such permeable element.

As used herein, the terms “heat seal”, “heat sealed”, “heat sealing”, “heat sealable”, and the like, refer to both a film layer which is heat sealable to itself or another thermoplastic film layer, and the formation of a fusion bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

As used herein, the term “cold seal”, refers to joining two surfaces by the application of glue or adhesive.

As used herein, the term “metallocene” refers to a compound typically consisting of two cyclopentadienyl anions (C₅H₅—, abbreviated as Cp) bound to a metal center (M) in an oxidation state II, with a resulting general formula (C₅H₅)₂M.

As used herein, the terms “polyolefin” and “polyolefin-based polymers” refer to polyethylene homopolymers, polyethylene copolymers, polypropylene homopolymers, or polypropylene copolymers.

As used herein, the term “polyethylene-based polymers” refers to polymers that include an ethylene linkage. Polyethylenes may be homopolymers, copolymers, or interpolymers. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear low-density polyethylene (LLDPE), medium-density polyethylene (MDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used herein, the term “high density polyethylene” or “HDPE” refers to both homopolymers of ethylene which have densities from about 0.960 gram per cubic centimeter (g/cm³) to about 0.970 g/cm³, and copolymers of ethylene and an alpha-olefin (usually 1-butene or 1-hexene) which have densities from about 0.940 g/cm³ to about 0.958 g/cm³. HDPE includes high molecular weight “polyethylenes.” The term “blown HDPE film” refers to a HDPE film manufactured by a blown film extrusion process.

As used herein, the terms “polypropylene” and “polypropylene-based polymers” refer to polymers that are derived from monomers of propylene. Polypropylenes may be homopolymers, copolymers, or interpolymers. Polypropylene copolymers or interpolymers may include other types of polymers (i.e., non-polypropylene polymers). Propylene linkage can be represented by the general formula: [CH2-CH(CH3)]n. Polypropylenes may have functional groups incorporated by grafting or other means. Polypropylenes include, but are not limited to, propylene-ethylene copolymers, ethylene-propylene copolymers, and maleic anhydride grafted polypropylenes (MAHgPP).

As used herein, the terms “ethylene/vinyl alcohol copolymer” and “EVOH” both refer to polymerized ethylene vinyl alcohol. Ethylene/vinyl alcohol copolymers include saponified (or hydrolyzed) ethylene/vinyl acrylate copolymers and refer to a vinyl alcohol copolymer having an ethylene comonomer prepared by, for example, hydrolysis of vinyl acrylate copolymers or by chemical reactions with vinyl alcohol. The degree of hydrolysis is, preferably, at least 50% and, more preferably, at least 85%. Preferably, ethylene/vinyl alcohol copolymers comprise from about 28-48 mole % ethylene, more preferably, from about 32-44 mole % ethylene, and, even more preferably, from about 38-44 mole % ethylene.

As used herein, the term “oriented” refers to a monolayer or multilayer film, sheet, or web which has been elongated in at least one of a machine direction or a transverse/cross direction. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving the tubular extrusion die is cooled, collapsed, and then oriented by reheating, reinflating to form a secondary bubble and recooling. Transverse direction orientation may be accomplished by inflation, radially expanding the heated film tube. Machine direction orientation may be accomplished by the use of nip rolls rotating at different speeds, pulling, or drawing the film tube in the machine direction. The combination of elongation at elevated temperature followed by cooling causes an alignment of the polymer chains to a more parallel configuration, thereby improving the mechanical properties of the film, sheet, web, package, or otherwise. Upon subsequent heating of an unrestrained, unannealed, oriented article to its orientation temperature, heat-shrinkage (as measured in accordance with American Society for Testing and Materials (ASTM) Test Method D2732, “Standard Test Method for Unrestrained Linear Thermal Shrinkage of Plastic Film and Sheeting”) may be produced. Heat-shrinkage may be reduced if the oriented article is annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line from (in a separate process) the orientation process.

As used herein, the terms “unoriented” and “non-oriented” refer to a monolayer or multilayer film, sheet, or web that is substantially free of post-extrusion orientation.

As used herein, the term “printed indicia” refers to a marking, image, text, and/or symbol located on the surface of a film, sheet, or web. The printed indicia can be placed on the surface by any suitable means (e.g., ink printing, laser printing, etc.). The indicia can include, e.g., a printed message or instructions, list of ingredients (active and inactive), weight of product, manufacturer name and address, manufacturer trademark, etc.

As used herein, the term “polyester” refers to homopolymers and copolymers having recurring ester linkages which may be formed by any method known in the art. Recurring ester linkages may be formed by the reaction of one or more diols with one or more diacids. Non-limiting examples of suitable diols include ethylene glycol, diethylene glycol, 1,3-propanediol, 1,4-butanediol, resorcinol, 1,4-cyclohexanedimethanol, 2,2,4,4-tetramethyl-1,3-cyclobutanediol, and polyoxytetramethylene glycol. Non-limiting examples of suitable diacids include terephthalic acid, isophthalic acid, 2,6-naphthalene dicarboxylic acid, 2,5-furandicarboxylic acid, 1,4-cyclohexane dicarboxylic acid, trimellitic anhydride, succinic acid, adipic acid, and azelaic acid.

Non-limiting examples of suitable polyesters include poly(ethylene terephthalate) (PET), poly(ethylene terephthalate-co-cyclohexanedimethanol terephthalate) (PETG), poly(butylene terephthalate) (PBT), poly(ethylene naphthalate) (PEN), poly(ethylene furanoate) (PEF), poly(propylene furanoate) (PPF), and poly(butylene adipate-co-terephthalate) (PBAT).

Suitable polyesters may also be formed by the ring-opening polymerization of suitable cyclic monomers like lactides to form, for example, poly(lactic acid) (PLA), glycolides to form, for example, poly(glycolic acid) (PGA), and lactones to form, for example, poly(caprolactone) and poly(butyrolactone).

Suitable polyesters may also be formed by the direct condensation reaction of alpha hydroxy acids. For example, PGA may be formed by the condensation reaction of glycolic acid.

Suitable polyesters may also be synthesized by microorganisms. Examples of suitable polyesters include various poly(hydroxy alkanoates) like poly(hydroxy butyrate) (PHB) and poly(hydroxy valerate) (PHV).

As used herein, the term “compatibilizer” refers to an interfacial agent that modifies the properties of an immiscible polymer blend or composite which facilitates formation of a uniform blend and increases interfacial adhesion between the phases. The compatibilizers may be made of two parts: one compatible with one of the two polymers to be compatibilized and the other part compatible with the second polymer. The compatibilizer may be reactive and link with polymers or nonreactive and only miscible with polymers.

Examples of reactive compatibilizers include acrylic functions (e.g., maleic anhydride, glycidyl methacrylate) grafted on polyolefin, polyethylene, and polypropylene (PP), that allow compatibilization with polyamide (PA), ethylene vinyl alcohol (EVOH), polybutylene terephthalate (PBT), and polyester (PET). Examples of non-reactive compatibilizers include ethylene-ethylacrylate (EEA) copolymers for PP/PA recycling; and ethylene-butylacrylate (EBA) and ethylene methacrylate (EMA) copolymer for compatibilization of PP, PE, PBT, PA, acrylonitrile butadiene styrene (ABS), and polycarbonate (PC). Poly-methyl methacrylate (PMMA) or polystyrene grafted on PP may compatibilize polypropylene with PMMA, styrene-acrylonitrile (SAN), acrylonitrile styrene acrylate (ASA), ABS, polyvinyl chloride (PVC), PC, and polyphenylene ether (PPE). Acrylic-imide copolymers may compatibilize PPE/PA, and PC/PE. Styrenic block copolymers may compatibilize PP/HDPE, PPE/PA, olefins and styrenics styrene-butadiene (SB), PS, and ABS. One example of compatibilizer includes random ethylene-methyl acrylate-glycidyl methacrylate terpolymer.

As used herein, the term “chemically incompatible-to-PE polymer” refers to polymers having a different chemical affinity from polyethylene. For example, the chemically incompatible-to-PE polymers may be polar. The chemically incompatible-to-PE polymers may have a higher melting point than polyethylene. Examples of chemically incompatible-to-PE polymer may include polyester, EVOH, PA, PC, PBT, and the like.

As used herein, the term “droplet” refers to any piece or segment of a polymer. It is not meant to imply any particular size of particle, as the polymer particle can be of any size, such as microscopic pieces, powders, to visible grains. Further, it is not meant to imply any particular shape, as a polymer particle can have any shape.

For example, droplets may have a “spheroid” shape with smoothed surfaces, rounded edges and corners, and a generally orbicular shape. However, the term “spheroid” is not meant to imply that such particles have only a perfectly spherical shape. The term “spheroid” refers to a generally spherical shape, for example, a globule, egg, or bead shape, and also relate to an elongated sphere shape such as a capsule or rod shape. Further, the term “spheroid” also relates to a flattened sphere that has a disk, pill, or pellet shape. The droplets may also have a “non-spheroid” shape, i.e., a shape of a polymer particle that is other than “spheroid,” as defined above. The “non-spheroid” particles may have rough surfaces, jagged edges, and/or sharp corners.

As used herein, the term “extrusion process” refers to the process of forming continuous shapes by forcing a molten plastic material through a die, followed by cooling and solidification.

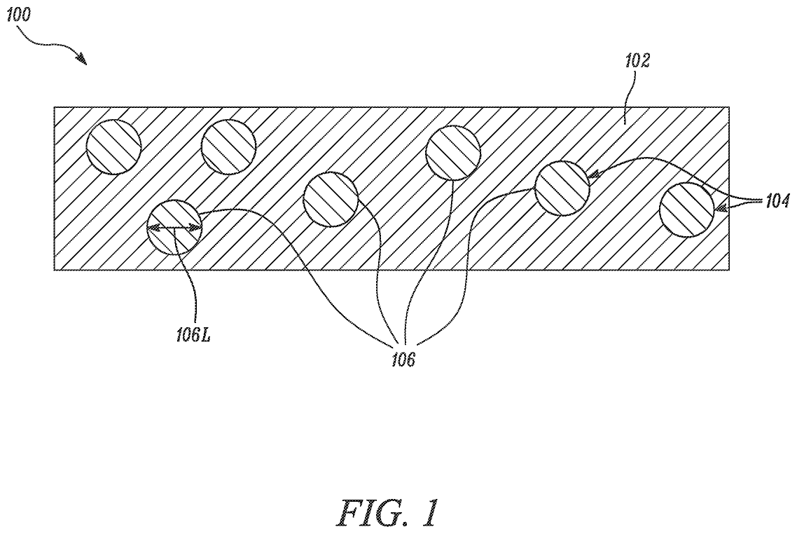

FIG. 1 shows a schematic cross-sectional view of a film 100 in accordance with an embodiment of the present disclosure.

Film 100 includes a matrix phase 102 including polyolefins. Specifically, in some embodiments, matrix phase 102 includes polyethylene, polypropylene, or combinations thereof. In some embodiments, matrix phase 102 may include polyethylene-based polymers, polypropylene-based polymers, or combinations thereof.

In some embodiments, the polyethylene includes ultra-low-density polyethylene (ULDPE), low density polyethylene (LDPE), linear low-density polyethylene (LLDPE), medium density polyethylene (MDPE), linear medium density polyethylene (LMDPE), metallocene LDPE, high density polyethylene (HDPE), ethylene vinyl acetate copolymer (EVA), or combinations thereof.

Examples of the polypropylene-based polymers may include polypropylene homopolymer, polypropylene random copolymer (PPR or PP-R), polypropylene terpolymer, heterophasic propylene copolymer, rubber modified polypropylene copolymer, and the like.

In some embodiments, matrix phase 102 includes polyolefin in the amount of 75% to 99.5% by weight of film 100. In some embodiments, matrix phase 102 may include polyolefin in the amount of at least 75%, at least 80%, at least 85%, at least 90%, at least 95%, or at least 99% by weight of film 100.

In some embodiments, matrix phase 102 includes polyethylene in the amount of 75% to 99.5% by weight of film 100. In some embodiments, matrix phase 102 may include polyethylene in the amount of at least 75%, at least 80%, at least 85%, at least 90%, at least 95%, or at least 99% by weight of film 100. The polyethylene may include a melting point from 80 degrees Celsius (° C.) to 135° C. That is, the polyethylene may include the melting point from 176 degrees fahrenheit (° F.) to 275° F.

Film 100 further includes a dispersion phase 104 including a chemically incompatible-to-PE polymer. The chemically incompatible-to-PE polymer of dispersion phase 104 may have a higher melting point than the polyolefins of matrix phase 102. In some embodiments, the chemically incompatible-to-PE polymer includes polyester. However, in some other embodiments, the chemically incompatible-to-PE polymer may include ethylene vinyl alcohol (EVOH), polyamide (PA), polycarbonate, polybutylene terephthalate (PBT), and the like.

In some embodiments, dispersion phase 104 includes the polyester in the amount of 0.5% to 25% by weight of film 100. In some embodiments, dispersion phase 104 may include polyester in the amount of less than 1%, less than 5%, less than 10%, less than 15%, less than 20%, or less than 25% by weight of film 100. In some embodiments, the polyester includes post-industrial recycled (PIR) polyester or post-consumer recycled (PCR) polyester. In some embodiments, the polyester includes a melting point from 250° C. to 290° C. That is, in some embodiments, the polyester includes the melting point from 482° F. to 554° F.

Dispersion phase 104 further includes droplets 106. Droplets 106 are dispersed in matrix phase 102. Droplets 106 may have a spheroid shape or a non-spheroid shape. 90% of droplets 106 include an average length 106L of 0.2 microns to 5.0 microns. In some embodiments, 90% of droplets 106 may include average length 106L of about 0.5 microns, about 1 micron, about 1.5 microns, about 2 microns, about 2.5 microns, about 3 microns, about 3.5 microns, about 4 microns, about 4.5 microns, or about 5 microns. Droplets 106 may be formed by micronization of a polymeric material, such as polyester.

In some embodiments, film 100 further includes a compatibilizer. The compatibilizer may include maleic anhydride, acrylates, and the like. The compatibilizer may assist in compatibilization of the polyolefins of matrix phase 102 and the chemically incompatible-to-PE polymer of dispersion phase 104. In some embodiments, film 100 may include the compatibilizer in the amount of about 1% to about 10% by weight of film 100. In some embodiments, film 100 may include the compatibilizer in the amount of about 5% by weight of film 100. However, the compatibilizer is optional, and may be omitted from film 100.

In the illustrated embodiment of FIG. 1, film 100 is a mono-layer film. However, in some other embodiments, film 100 is a multilayer film. Moreover, in some embodiments, film 100 is a coextruded film. In other words, film 100 may have two or more layers that are coextruded with each other.

Film 100 may utilize polyester-containing waste, which is generally disposed of in landfills and incineration facilities. As a result, film 100 may be sustainable due to use of a recycled material (i.e., recycled polyester-containing waste). Furthermore, film 100 may have increased stiffness due to the micronized polyester (i.e., droplets 106) when compared to a polyolefin-based film that does not include micronized polyester. The increase of stiffness may further allow use of less material (downgauging) for packaging purposes.

Film 100 may be made without using a complicated chemical separation process. Film 100 may be made by recycling a PET/PE structure without use of compatibilizers in order to promote micronization of the PET of the PET/PE structure. The compatibilizers may be optionally added during extrusion of film 100 after the micronization of the PET. Therefore, film 100 may be environmentally and economically friendly.

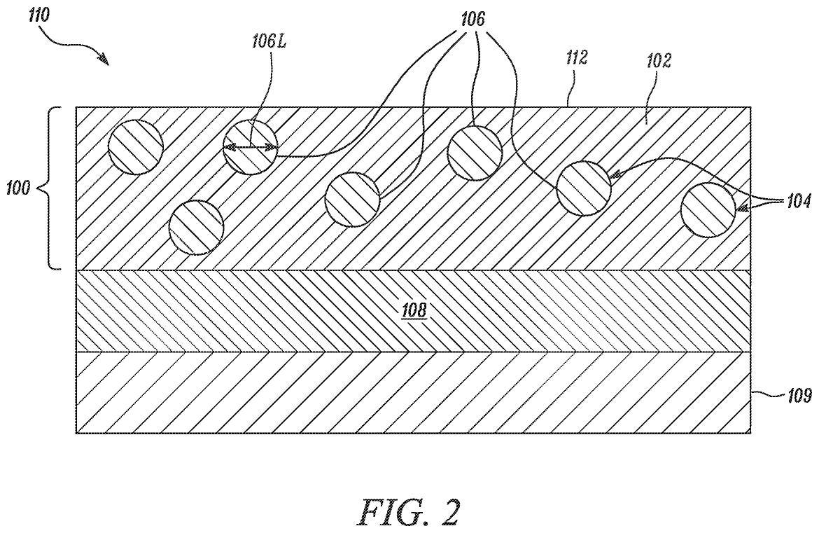

FIG. 2 shows a schematic cross-sectional view of a laminated film 110 in accordance with another embodiment of the present disclosure.

In the illustrated embodiment of FIG. 2, laminated film 110 includes film 100. Specifically, in the illustrated embodiment of FIG. 2, laminated film 110 further includes a second film 108 laminated to film 100. Furthermore, in the illustrated embodiment of FIG. 2, film 100 further includes an exposed surface 112 of laminated film 110.

Second film 108 may be laminated to film 100 by any suitable lamination process. Non-limiting examples of lamination processes include flame lamination, hot roll lamination, cold lamination, belt lamination, ultrasonic lamination, calender lamination, and extrusion lamination. In some embodiments, film 100 and second film 108 may be laminated by heat, extrusion, or adhesive. Any suitable adhesive may be used to laminate second film 108 to film 100, based on application requirements. For example, the adhesive may be selected from the group consisting of polyurethane dispersions, acrylic emulsions, water-based polyvinyl alcohol, vinyl acetate copolymers, modified polyolefins, polyesters, synthetic or natural rubber, solvent-based acrylics, one or two component solvent-based polyurethanes, and radiation-curable adhesives.

In some embodiments, second film 108 is oriented. Specifically, second film 108 may be machine direction oriented or transverse direction oriented, based upon application requirements. However, in some other embodiments, second film 108 is non-oriented. In other words, in some embodiments, second film 108 is unoriented.

In the illustrated embodiment of FIG. 2, laminated film 110 further includes a substrate 109. Substrate 109 may be disposed on second film 108. In some embodiments, substrate 109 includes oriented polyester, oriented nylon, or oriented polypropylene. In some embodiments, substrate 109 may include oriented polymer films, metallized films, release liners, foil, paper, polyethylene, biopolymers, and the like.

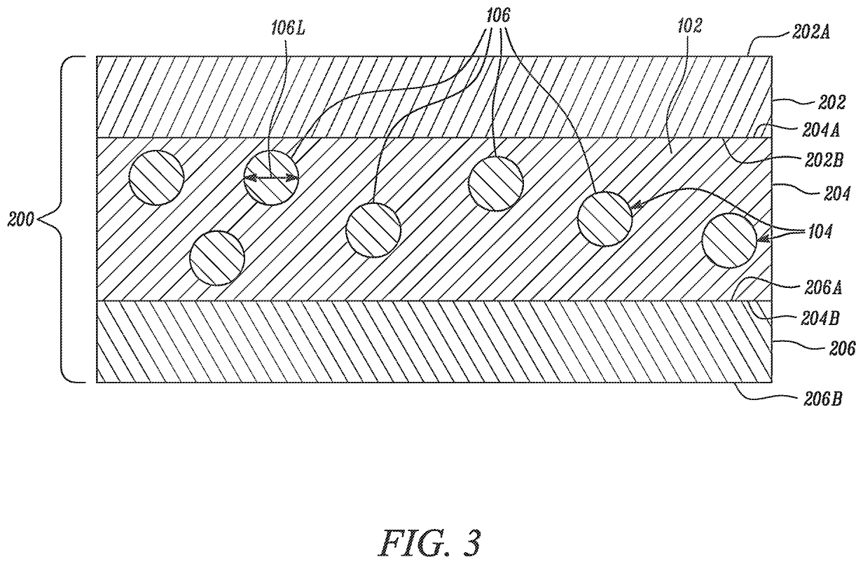

FIG. 3 shows a schematic cross-sectional view of a first film 200 in accordance with an embodiment of the present disclosure.

First film 200 is a multi-layer film. Specifically, first film 200 includes a first layer 202, a second layer 204, and a third layer 206, with each layer 202, 204, 206 including a first surface and an opposing second surface. Specifically, in the illustrated embodiment of FIG. 3, first layer 202 includes a first surface 202A and an opposing second surface 202B, second layer 204 includes a first surface 204A and an opposing second surface 204B, and third layer 206 includes a first surface 206A and an opposing second surface 206B.

First layer 202, second layer 204, and third layer 206 are coextruded with each other and positioned relative to each other in a sequential order. Specifically, first layer 202, second layer 204, and third layer 206 are coextruded with each other, such that first surface 204A of second layer 204 is disposed adjacent to second surface 202B of first layer 202, and first surface 206A of third layer 206 is disposed adjacent to second surface 204B of second layer 204.

First layer 202 and third layer 206 include polyethylene. Second layer 204 is substantially similar to film 100 (shown in FIG. 1), with like elements designated by like reference numerals. Specifically, second layer 204 includes matrix phase 102 including polyethylene in the amount of 75% to 99.5% by weight of first film 200 and dispersion phase 104 including polyester in the amount of 0.5% to 25% by weight of first film 200.

In some embodiments, the polyethylene of first, second and third layers 202, 204, 206 includes ultra-low-density polyethylene (ULDPE), low density polyethylene (LDPE), linear low-density polyethylene (LLDPE), medium density polyethylene (MDPE), linear medium density polyethylene (LMDPE), metallocene LDPE, high density polyethylene (HDPE), ethylene vinyl acetate copolymer (EVA), or combinations thereof.

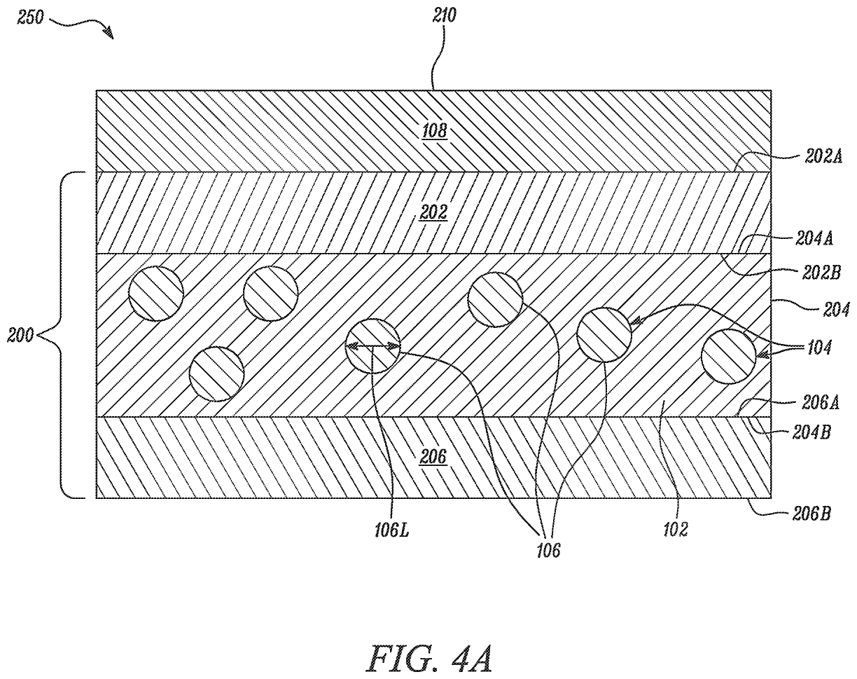

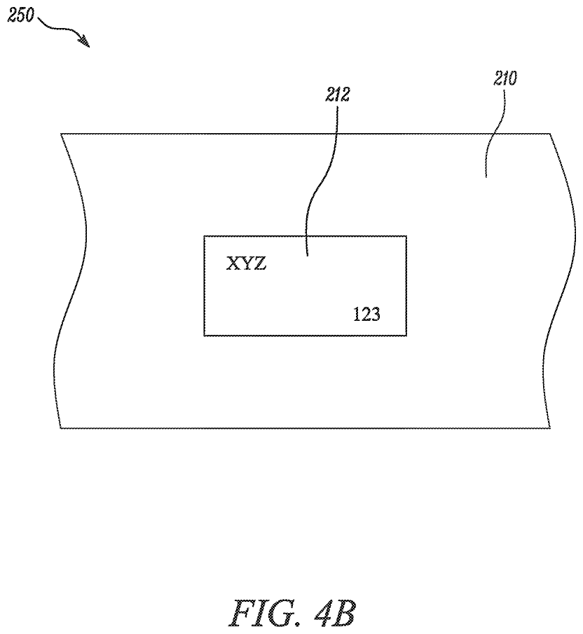

FIG. 4A shows a schematic cross-sectional view of a laminated film 250 in accordance with an embodiment of the present disclosure.

In the illustrated embodiment of FIG. 4A, laminated film 250 includes first film 200 and second film 108 laminated to first film 200. Specifically, in the illustrated embodiment of FIG. 4A, second film 108 is laminated to first film 200 on the first surface 202A of the first layer 202 of first film 200. Further, in the illustrated embodiment of FIG. 4A, second film 108 further includes an exposed surface 210 of laminated film 250. Second film 108 may be laminated to first film 200 by any suitable lamination process.

FIG. 4B shows a schematic top view of laminated film 250. Referring to FIGS. 4A and 4B, laminated film 250 further includes printed indicia 212 that is shown as “XYZ” and “123”. Printed indicia 212 may include any suitable combination of alphanumeric characters, symbols, visual or pictorial elements, colors, and the like. Printed indicia 212 may be formed by any suitable printing process, such as offset printing, flexography, rotogravure, digital printing process, and the like.

In some embodiments, printed indicia 212 may be printed on second film 108. Specifically, in some embodiments, printed indicia 212 may be printed on exposed surface 210 of laminated film 250. In some embodiments, printed indicia 212 may be printed on first film 200. Specifically, in some embodiments, printed indicia 212 may be printed on first surface 202A of first layer 202 of first film 200.

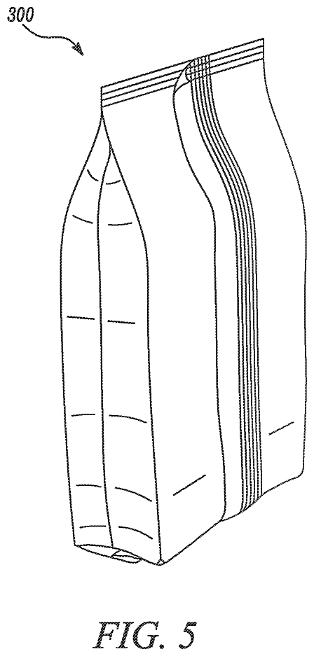

FIG. 5 shows a schematic perspective view of a package 300. In the illustrated embodiment of FIG. 5, package 300 is a gusseted pouch. However, in some other embodiments, package 300 may be, for example, a stand-up pouch, a pillow pouch, a retort pouch, a sachet, a brick bag, a flow wrap bag, a stickpack, and the like.

Referring to FIGS. 1 to 5, in some embodiments, package 300 includes film 100. In other words, in some embodiments, film 100 may be used to form package 300. In some embodiments, package 300 may include laminated film 110. In other words, in some embodiments, laminated film 110 may be used to form package 300. In some embodiments, package 300 includes laminated film 250. In other words, in some embodiments, laminated film 250 may be used to form package 300.

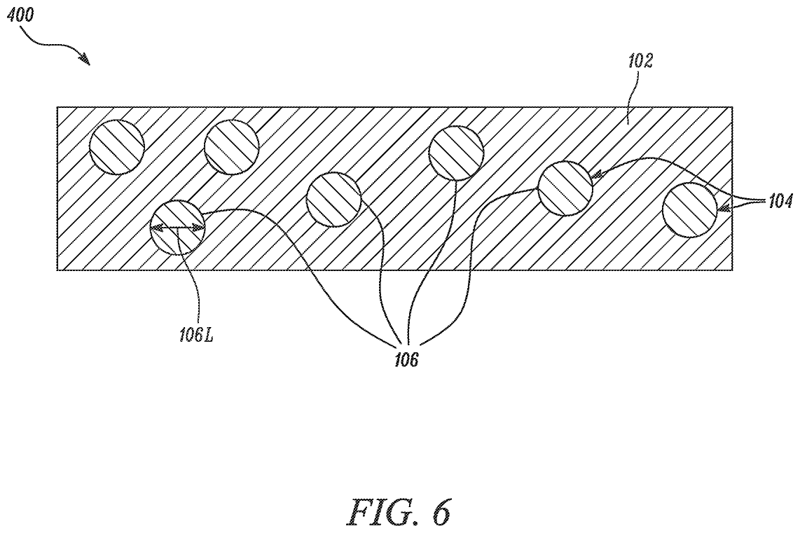

FIG. 6 shows a schematic cross-sectional view of a rigid article 400. Rigid article 400 may be any article that is injection molded, blow molded, thermoformed, rotational molded, 3-D printed, and the like. Non-limiting examples of rigid articles include injection molded filler resin for bottles, pallets, and plastic lumber. Rigid articles include little to no bendability.

Rigid article 400 is substantially similar to film 100, with like elements designated by like reference numerals. Specifically, rigid article 400 includes matrix phase 102 including polyethylene in the amount of 75% to 99.5% by weight of rigid article 400. However, in some embodiments, matrix phase 102 of rigid article 400 may include polyolefins other than polyethylene.

Rigid article 400 further includes dispersion phase 104 including polyester in the amount of 0.5% to 25% by weight of rigid article 400. However, in some embodiments, dispersion phase 104 of rigid article 400 may include any other chemically incompatible-to-PE polymer, such as ethylene vinyl alcohol (EVOH), polyamide (PA), polycarbonate, or polybutylene terephthalate (PBT). As shown in FIG. 6, dispersion phase 104 of rigid article 400 further includes droplets 106. Droplets 106 are dispersed in matrix phase 102. 90% of droplets include average length 106L of 0.2 microns to 5 microns.

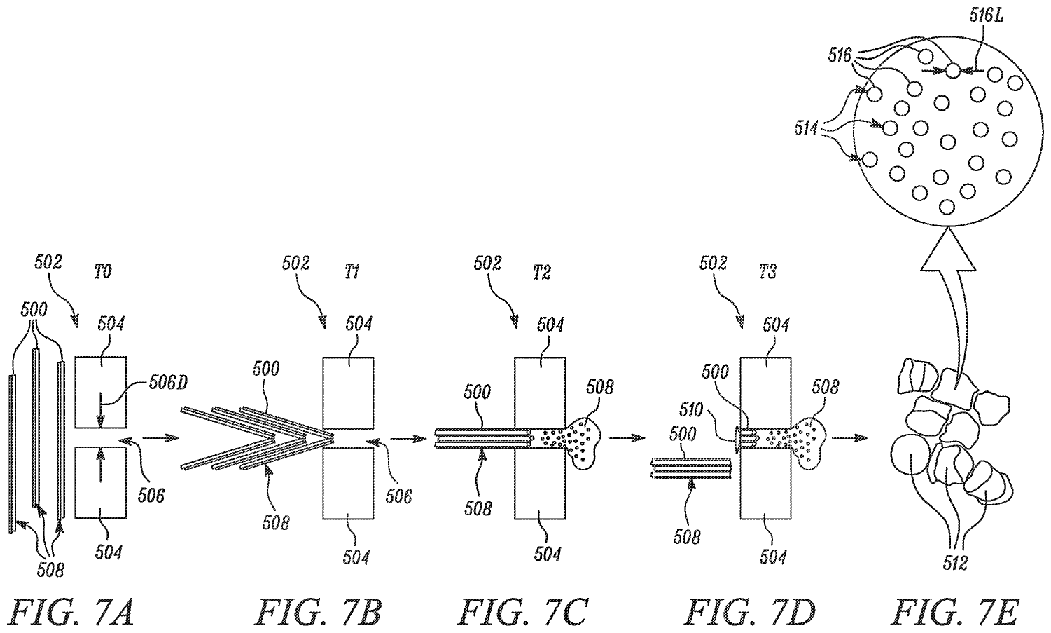

FIGS. 7A-7D show various steps of filtration and micronization of a polyethylene film 500 including from 10% to 15% of the chemically incompatible-to-PE polymer and 85% to 90% polyethylene, by weight of polyethylene film 500. Polyethylene film 500 may include, for example, post-industrial recycled (PIR) polyester or post-consumer recycled (PCR) polyester.

The filtration and micronization of polyethylene film 500 may be performed using a continuous melt filtration pelletizer 502. Continuous melt filtration pelletizer 502 shown in FIGS. 7A-7D includes a filter 504 including a plurality of apertures 506 (one shown in FIGS. 7A-7D) from 5 microns to 150 microns. For example, the plurality of apertures 506 may have a diameter 506D from 5 microns to 150 microns.

In some embodiments, polyethylene film 500 may be melted within a temperature range above a melting point of the polyethylene and at least 5% below a melting point of the chemically incompatible-to-PE polymer. Polyethylene film 500, once melted, may be fed through filter 504. A scraper disc (not shown) may remove filtered contaminants from filter 504 and dispose of the filtered contaminants. In some embodiments, a fixed knife may be used instead of the scraper disc. The fixed knife may be placed to filter a rotating drum having on its surface the polymeric mass to be filtered.

FIGS. 7A, 7B, 7C, and 7D correspond to steps T0, T1, T2, and T3, respectively, of filtration and micronization of polyethylene film 500. Prior to filtration and micronization, polyethylene film 500 is melted at the temperature range above the melting point of the polyethylene and at least 5% below the melting point of the chemically incompatible-to-PE polymer to form a melt 508. At step T0, melt 508 of polyethylene film 500 is obtained for filtration and micronization processes. At step T1, melt 508 of polyethylene film 500 is fed into filter 504 of continuous melt filtration pelletizer 502, specifically, into aperture 506 of filter 504. At step T2, melt 508 is received from an opposing side of filter 504. Melt 508 includes the polyethylene and the micronized chemically incompatible-to-PE polymer dispersed in the polyethylene. At step T3, a knife/blade 510 of continuous melt filtration pelletizer 502 scrapes melt 508 of polyethylene film 500 accumulated at a front of filter 504 to prevent clogging of filter 504.

FIG. 7E shows a schematic view of a plurality of pellets 512 in accordance with an embodiment of the present disclosure.

Referring to FIGS. 7A-7E, melt 508 may be cooled and solidified. After cooling and solidification, melt 508 may be extruded and formed into pellets 512. Pellets 512 may be formed using continuous melt filtration pelletizer 502, as described above.

Each pellet 512 includes a dispersed phase 514 including the chemically incompatible-to-PE polymer in the amount of less than 25% by weight of pellet 512. Dispersed phase 514 includes droplets 516 including an average length 516L from 0.2 microns to 5.0 microns.

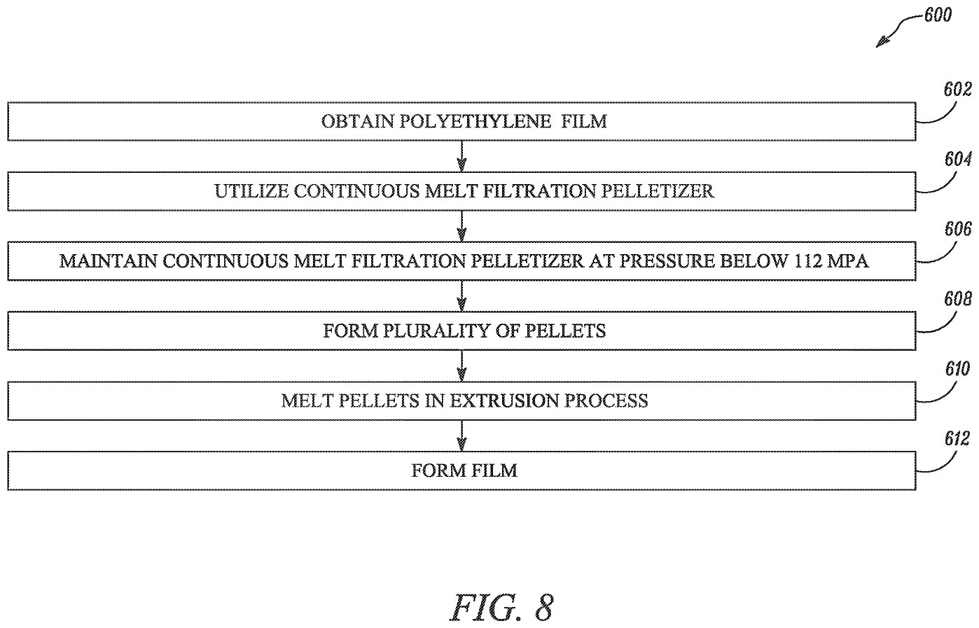

FIG. 8 shows a method 600 of making a film in accordance with an embodiment of the present disclosure. In some embodiments, method 600 may be used to make film 100 (shown in FIG. 1). In some embodiments, method 600 may be used to make second layer 204 of first film 200 (shown in FIG. 3). In some embodiments, method 600 may be used to make rigid article 400 (shown in FIG. 6). Method 600 will be described with reference to FIGS. 1 and 7A-7E.

At step 602, method 600 includes obtaining a polyethylene film including from 10% to 15% of a chemically incompatible-to-PE polymer and 85% to 90% polyethylene by weight. For example, method 600 may include obtaining polyethylene film 500 including from 10% to 15% of the chemically incompatible-to-PE polymer and 85% to 90% polyethylene by weight.

At step 604, method 600 further includes utilizing a continuous melt filtration pelletizer including a filter including a plurality of apertures from 5 microns to 150 microns within a temperature range above a melting point of the polyethylene and at least 5% below a melting point of the chemically incompatible-to-PE polymer. For example, method 600 may include utilizing continuous melt filtration pelletizer 502 including filter 504 including plurality of apertures 506 from 5 microns to 150 microns within the temperature range above the melting point of the polyethylene and at least 5% below the melting point of the chemically incompatible-to-PE polymer.

At step 606, method 600 further includes maintaining the continuous melt filtration pelletizer at a pressure below 112 megapascals (MPa). For example, method 600 may include maintaining continuous melt filtration pelletizer 502 at a pressure below 112 MPa.

At step 608, method 600 further includes forming a plurality of pellets. Each pellet includes a dispersed phase including the chemically incompatible-to-PE polymer in the amount of less than 25% by weight of the pellet. The dispersed phase includes droplets including an average length from 0.2 microns to 5.0 microns.

For example, method 600 may include forming plurality of pellets 512. Each pellet 512 may include dispersed phase 514 including the chemically incompatible-to-PE polymer in the amount of less than 25% by weight of the pellet. Dispersed phase 514 may include droplets 516 including average length 516L from 0.2 microns to 5.0 microns.

The plurality of pellets 512 may be formed without use of compatibilizers in order to promote micronization of the chemically incompatible-to-PE polymer of polyethylene film 500.

At step 610, method 600 further includes melting the pellets in an extrusion process. For example, method 600 may further include melting pellets 512 in an extrusion process. In some examples, compatibilizers may be optionally added at the extrusion process.

At step 612, method 600 further includes forming a film that includes a matrix phase including polyethylene in the amount of 75% to 99.5% by weight of the film and a dispersion phase of the chemically incompatible-to-PE polymer in the amount of 0.5% to 25% by weight of the film. For example, method 600 may include forming film 100 that includes matrix phase 102 including the polyethylene in the amount of 75% to 99.5% by weight of film 100 and dispersion phase 104 comprising the chemically incompatible-to-PE polymer in the amount of 0.5% to 25% by weight of film 100.

Method 600 may allow reuse of polyester-containing waste. Specifically, method 600 may utilize polyester-containing post-industrial recycled (PIR) waste and/or polyester-containing post-consumer recycled (PCR) waste. Therefore, method 600 may be environmentally and economically friendly.

### EXAMPLES

The following illustrative examples are merely meant to exemplify the present invention, but they are not intended to limit or otherwise define the scope of the present disclosure.

In the following examples, the following resin grades were used:
HDPE: AC59 available from Braskem (São Paulo, Brazil).
LLDPE: DOWLEX 2085 available from Dow Chemical Company (Houston, TX, USA).
LDPE: DOW 219M available from Dow Chemical Company (Houston, TX, USA).
White Masterbatch: 911082 available from Ampacet (Tarrytown, New York, USA).
Compatibilizer: LOTADER AX8900 available from SK Functional Polymer (Paris, France).

In the following examples, PIR material refers to a post-industrial recycled material including polyethylene in the amount of 81.7%, by weight of the PIR material, and micronized polyester in the amount of 14.4%, by weight of the PIR material. Composition of the PIR material is provided in Table 1 below.

TABLE 1

| | % Volume | % Weight |
|---|---|---|
| | in PIR material | in PIR material |
| PET | 10.4% | 14.4% |
| PE | 87.0% | 81.7% |
| Ink | 0.9% | 0.9% |
| Adhesive | 1.7% | 1.7% |

### Example 1

A packaging film of the following structure, 48-gauge (12 microns) OPET/Ink/Adhesive/4.0 mil (102 microns) white HDPE-mLLDPE, was recycled using a continuous melt filtration process utilizing a continuous melt filtration pelletizer (e.g., continuous melt filtration pelletizer 502 shown in FIGS. 7A-7D) commercially available from Erema. Further, the packaging film was extruded within the temperature range above the melting point of the polyethylene and at least 5% below the melting point of the polyester and formed into a plurality of first pellets (e.g., pellets 512). The plurality of first pellets was compressed and cryofractured for scanning electron microscope (SEM) analysis.

### Example 2

Another packaging film of the following structure, 48-gauge (12 microns) OPET/Ink/Adhesive/4.0 mil (102 microns) white HDPE-mLLDPE, was recycled using a continuous melt filtration process utilizing a continuous melt filtration pelletizer (e.g., continuous melt filtration pelletizer 502 shown in FIGS. 7A-7D) commercially available from NGR/Ettlinger. Further, the packaging film was extruded within the temperature range above the melting point of the polyethylene and at least 5% below the melting point of the polyester and formed into a plurality of second pellets (e.g., pellets 512). The plurality of second pellets was compressed and cryofractured for scanning electron microscope (SEM) analysis.

Example 3 through Example 14 included a multi-layer structure. Each Example film included a first layer, a second layer and a third layer. The first layer had a weight percentage of 30% in the Example film. The second layer had a weight percentage of 40% in the Example film. The third layer had a weight percentage of 30% in the Example film.

Example 3: A comparative packaging film was formed. The comparative packaging film did not include any PET-containing PIR or PET-containing PCR.

The first layer included 70% LLDPE and 30% LDPE.

The second layer included 70% HDPE, 15% LDPE, and 15% white masterbatch.

The third layer included 70% LLDPE and 30% LDPE.

Example 4: A packaging film was developed. The packaging film included 100% of post-industrial recycled (PIR) material of Table 1, by weight, made using a continuous melt filtration pelletizer provided by NGR/Ettlinger.

Example 5: A packaging film was developed. The packaging film included 100% PIR material of Table 1, by weight, made using a continuous melt filtration pelletizer provided by Erema.

Example 6: A packaging film was developed.

The first layer included 70% LLDPE and 30% LDPE.

The second layer included 60% HDPE, 25% PIR material (shown in Table 1) made using a continuous melt filtration pelletizer provided by NGR/Ettlinger, and 15% white masterbatch.

The third layer included 70% LLDPE and 30% LDPE.

Example 7: A packaging film was developed.

The first layer included 70% LLDPE and 30% LDPE.

The second layer included 60% HDPE, 25% PIR material (shown in Table 1) made using a continuous melt filtration pelletizer provided by Erema, and 15% white masterbatch.

The third layer included 70% LLDPE and 30% LDPE.

Example 8: A packaging film was developed.

The first layer included 70% LLDPE and 30% LDPE.

The second layer included 55% HDPE, 25% PIR material (shown in Table 1) made using a continuous melt filtration pelletizer provided by NGR/Ettlinger, 15% white masterbatch, and 5% compatibilizer.

The third layer included 70% LLDPE and 30% LDPE.

Example 9: A packaging film was developed.

The first layer included 70% LLDPE and 30% LDPE.

The second layer included 55% HDPE, 25% PIR material (shown in Table 1) made at a continuous melt filtration pelletizer provided by Erema, 15% white masterbatch, and 5% compatibilizer.

The third layer included 70% LLDPE and 30% LDPE.

Example 10: A packaging film was developed.

The first layer included 70% LLDPE and 30% LDPE.

The second layer included 35% HDPE, 50% PIR material (shown in Table 1) made using a continuous melt filtration pelletizer provided by NGR/Ettlinger, and 15% white masterbatch.

The third layer included 70% LLDPE and 30% LDPE.

Example 11: A packaging film was developed.

The first layer included 70% LLDPE and 30% LDPE.

The second layer included 35% HDPE, 50% PIR material (shown in Table 1) made using a continuous melt filtration pelletizer provided by Erema, and 15% white masterbatch.

The third layer included 70% LLDPE and 30% LDPE.

Example 12: A packaging film was developed.

The first layer included 70% LLDPE and 30% LDPE.

The second layer included 30% HDPE, 50% PIR material (shown in Table 1) made using a continuous melt filtration pelletizer provided by NGR/Ettlinger, 15% white masterbatch, and 5% compatibilizer.

The third layer included 70% LLDPE and 30% LDPE.

Example 13: A packaging film was developed.

The first layer included 70% LLDPE and 30% LDPE.

The second layer included 30% HDPE, 50% PIR material (shown in Table 1) made using a continuous melt filtration pelletizer provided by Erema, 15% white masterbatch, and 5% compatibilizer.

The third layer included 70% LLDPE and 30% LDPE.

Example 14: A packaging film was developed.

The first layer included 70% LLDPE and 30% LDPE.

The second layer included 30% HDPE, 50% PIR material (shown in Table 1) made using a continuous melt filtration pelletizer provided by Erema, 15% LDPE, and 5% compatibilizer.

The third layer included 70% LLDPE and 30% LDPE.

### Experimental Results

Experiments were conducted on different cryofractured pellets (i.e., Examples 1 and 2) and packaging films (i.e., Examples 3 through 14) to determine their seal, tensile, and tear properties.

Experiment 1: Referring to Example 1, a first pellet from the plurality of first pellets was examined with a scanning electron microscope (SEM).

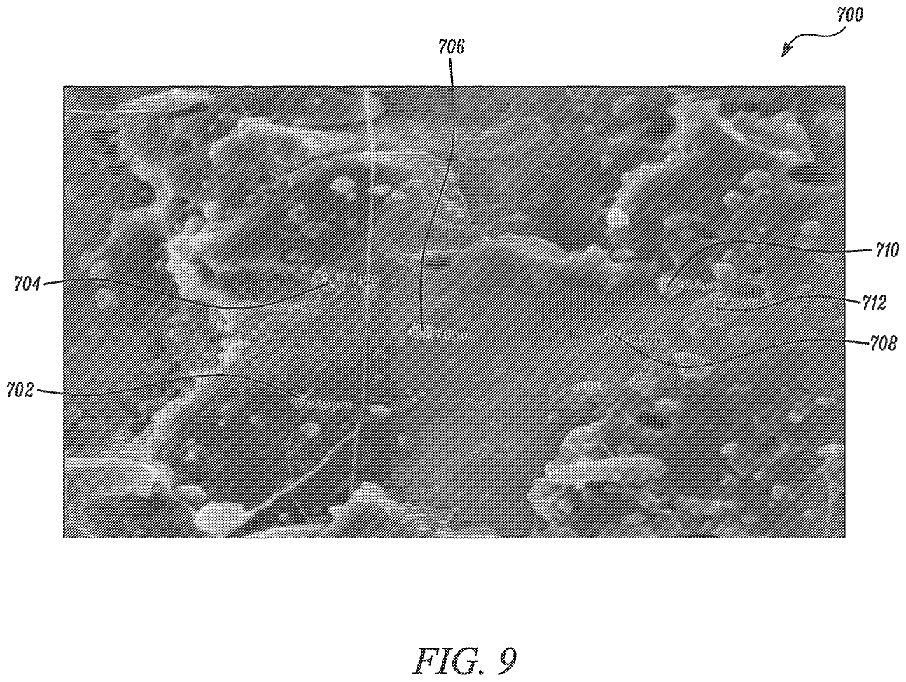

FIG. 9 shows a SEM photograph 700 of the first pellet of Example 1. SEM photograph 700 depicts that the first pellet included a plurality of micro-droplets of polyester including a first droplet 702, a second droplet 704, a third droplet 706, a fourth droplet 708, a fifth droplet 710, and a sixth droplet 712. First droplet 702 included a maximum length of 0.849 microns. Second droplet 704 included a maximum length of 2.161 microns. Third droplet 706 included a maximum length of 1.276 microns. Fourth droplet 708 included a maximum length of 0.885 microns. Fifth droplet 710 included a maximum length of 1.498 microns. Sixth droplet 712 included a maximum length of 2.240 microns. A maximum length of the micro-droplets of polyester in the first pellet made using a continuous melt filtration pelletizer provided by Erema was between 0.5 microns to 2.2 microns.

Experiment 2: Referring to Example 2, a second pellet from the plurality of second pellets was examined with the SEM.

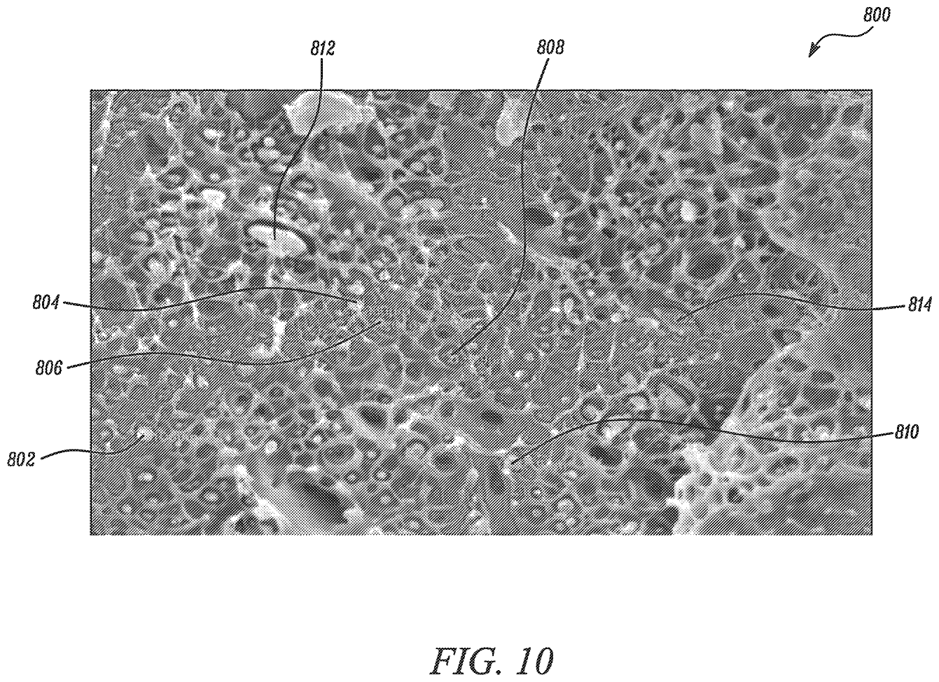

FIG. 10 shows a SEM photograph 800 the second pellet of Example 2. SEM photograph 800 depicts that the second pellet included a plurality of micro-droplets of the polyester including a first droplet 802, a second droplet 804, a third droplet 806, a fourth droplet 808, and a fifth droplet 810. First droplet 802 included a maximum length of 1.106 microns. Second droplet 804 included a maximum length of 0.960 microns. Third droplet 806 included a maximum length of 0.646 microns. Fourth droplet 808 included a maximum length of 0.569 microns. Fifth droplet 810 included a maximum length of 1.219 microns. A maximum length of the micro-droplets of polyester in the second pellet made using a continuous melt filtration pelletizer provided by NGR/Ettlinger was between 0.5 microns to 1.2 microns.

SEM photograph 800 further depicts that the second pellet included micro-particles of titanium dioxide including a first particle 812 and a second particle 814. As shown in FIG. 10, a number of micro-particles of titanium dioxide in the second pellet was lower than a number of the micro-droplets of the polyester in the second pellet. However, an average length of micro-particles of the titanium dioxide in the second pellet was greater than an average length the micro-droplets of the polyester in the second pellet.

Experiment 3: Packaging films corresponding to Examples 3 and 6-14 were tested using a dart drop impact test to determine their impact resistance.

Approximate peak loads (in pounds or lb) on the packaging films corresponding to Examples 3 and 6-14 are provided in Table 2 below.

TABLE 2

| Example | Peak Load (lb) |
|---|---|
| 3 | 21.8 |
| 6 | 19.6 |
| 7 | 18.75 |
| 8 | 15.7 |
| 9 | 17.1 |
| 10 | 17.3 |
| 11 | 16 |
| 12 | 15.3 |
| 13 | 16.25 |
| 14 | 15.7 |

Reported data of Table 2 was obtained using ASTM D7192-10. Further, the reported data of Table 2 may be represented in SI units by a conversion factor of 0.454 with the units of Kilograms (kg), for example, 21.8 lb is equal to 9.89 kg.

Approximate total deformations (in inches or in) of the packaging films corresponding to Examples 3 and 6-14 are provided in Table 3 below.

TABLE 3

| Example | Total Deformation (in) |
|---|---|
| 3 | 1.36 |
| 6 | 1.20 |
| 7 | 1.10 |
| 8 | 1.13 |
| 9 | 1.10 |
| 10 | 1.19 |
| 11 | 1.12 |
| 12 | 1.10 |
| 13 | 1.30 |
| 14 | 1.14 |

Reported data of Table 3 was obtained using ASTM D7192-10. Further, the reported data of Table 3 may be represented in SI units by a conversion factor of 0.0254 with the units of meter (m), for example, 1.36 in is equal to 0.0345 m.

Experiment 4: Packaging films corresponding to Examples 3 and 6-14 were tested using an Elmendorf tear test with a 1600-gram pendulum to determine their tear resistance.

Approximate tear resistances (in g) of the packaging films corresponding to Examples 3 and 6-14 are provided in Table 4 below.

TABLE 4

| Example | Tear Resistance (g) |
|---|---|
| 3 | 708 |
| 6 | 738 |
| 7 | 662 |
| 8 | 907 |
| 9 | 854 |
| 10 | 985 |
| 11 | 1046 |
| 12 | 1000 |
| 13 | 605 |
| 14 | 662 |

Reported data of Table 4 was obtained using ASTM D1922-09.

Experiment 5: Packaging films corresponding to Examples 3 and 6-14 were tested using a loop stiffness test to determine their loop stiffness properties. For loop stiffness measurement, an Instron® tensile tester from Instron Corporation. Norwood, MA, USA, was used having a 100-pound (approximately 45.36 kilogram) load cell. Specimen samples were prepared by cutting a 4 inch (10.16 cm) by 4 inch (10.16 cm) sample of each material and folding opposing ends of the sample towards themselves to form a loop. The folded sample was placed into a specimen holding fixture so that the opposing sides of the sample were separated by a distance of 1.0 inch (2.54 cm). A 0.25 inch (0.635 cm) thick by 5 inch (12.7 cm) long stainless steel test probe was fitted to an Instron® mechanical testing instrument. The instrument was set to the “stiffness” internal protocol. The amount of force required to bend or deflect the sample approximately 0.5 inch (1.27 centimeter) at the vertex of the loop was measured.

Approximate loop stiffnesses (in gram force or gf) of the packaging films corresponding to Examples 3 and 6-14 in a machine direction (MD) and in a transverse direction (TD) are provided in Table 5 below.

TABLE 5

| | Loop Stiffness | Loop Stiffness |
|---|---|---|
| Example | (gf) MD | (gf) TD |
| 3 | 11.6 | 9.9 |
| 6 | 10.5 | 10.4 |
| 7 | 8.5 | 8.7 |
| 8 | 6.7 | 6.4 |
| 9 | 7.7 | 8.8 |
| 10 | 8.5 | 8.4 |
| 11 | 7.9 | 7.2 |
| 12 | 6.3 | 6.5 |
| 13 | 6.1 | 6.3 |
| 14 | 6.3 | 6.7 |

Reported data of Table 5 may be represented in SI units by a conversion factor of 0.0098 with the units of Newton (N), for example, 11.6 gf is equal to 0.11375714 N.

Experiment 6: Packaging films corresponding to Examples 3 and 6-14 were tested using a puncture test to determine their puncture resistance.

Approximate puncture resistances (in pounds or lb) of the packaging films corresponding to Examples 3 and 6-14 are provided in Table 6 below.

TABLE 6

| Example | Puncture Resistance (lb) |
|---|---|
| 3 | 2.6 |
| 6 | 2.25 |
| 7 | 2.9 |
| 8 | 2.2 |
| 9 | 2.6 |
| 10 | 2.7 |
| 11 | 2.55 |
| 12 | 2.5 |
| 13 | 1.95 |
| 14 | 2.25 |

Reported data of Table 6 was obtained using ASTM F1306-16. Further, the reported data of Table 6 may be represented in SI units by a conversion factor of 0.454 with the units of Kilograms (kg), for example, 2.6 lb is equal to 1.179 kg.

Experiment 7: Packaging films corresponding to Examples 3 and 6-14 were tested using a tensile test to determine their tensile properties.

Approximate stresses at break (in pound per square inch or psi) of the packaging films corresponding to Examples 3 and 6-14 in the MD and in the TD are provided in Table 7 below.

TABLE 7

| | Stress at Break | Stress at Break |
|---|---|---|
| Example | MD (psi) | TD (psi) |
| 3 | 3500 | 3500 |
| 6 | 2910 | 2864 |
| 7 | 3000 | 3160 |
| 8 | 2910 | 2500 |
| 9 | 2775 | 2950 |
| 10 | 2640 | 2620 |
| 11 | 2475 | 2640 |
| 12 | 2160 | 2590 |
| 13 | 2115 | 2705 |
| 14 | 2480 | 2340 |

Reported data of Table 7 was obtained using ASTM D882-12. Further, the reported data of Table 7 may be represented in SI units by a conversion factor of 6984.76 with the units of Pascal (Pa), for example, 1 psi is equal to 6984.76 Pa.

Approximate elongations at break (in %) of the packaging films corresponding to Examples 3 and 6-14 in the MD and in the TD are provided in Table 8 below.

TABLE 8

| | Elongation at | Elongation at |
|---|---|---|
| Example | Break in MD (%) | Break in TD (%) |
| 3 | 920 | 990 |
| 6 | 850 | 900 |
| 7 | 850 | 925 |
| 8 | 890 | 850 |
| 9 | 840 | 900 |
| 10 | 840 | 850 |
| 11 | 800 | 890 |
| 12 | 750 | 860 |
| 13 | 770 | 850 |
| 14 | 840 | 820 |

Reported data of Table 8 was obtained using ASTM D882-12.

Approximate moduli of the packaging films corresponding to Examples 3 and 6-14 in the MD and in the TD are provided in Table 9 below.

TABLE 9

| | Modulus at Break | Modulus at Break |
|---|---|---|
| Example | MD (psi) | TD (psi) |
| 3 | 62500 | 71000 |
| 6 | 55000 | 70200 |
| 7 | 61000 | 80500 |
| 8 | 42500 | 52500 |
| 9 | 46250 | 55000 |
| 10 | 49000 | 60500 |
| 11 | 35000 | 45000 |
| 12 | 35500 | 44500 |
| 13 | 39000 | 42500 |
| 14 | 42500 | 43750 |

Reported data of Table 9 was obtained using ASTM D882-12. Further, the reported data of Table 9 may be represented in SI units by a conversion factor of 6984.76 with the units of Pascal (Pa), for example, 1 psi is equal to 6984.76 Pa.

The tests measuring seal, tensile, and tear properties for Examples 3 and 6-14 indicate that the presence of micronized polyester dispersed in a PE structure did not substantially change any of the physical properties due to the addition of the PIR material.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. (canceled)

2. The film of claim 17, wherein the film is a coextruded film.

3. The film of claim 17, wherein the film is a multilayer film.

4. The film of claim 18, wherein the polyethylene comprises ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.

5. The film of claim 17, wherein the chemically incompatible-to-PE polymer comprises polyester and the polyester comprises a melting point from 250° C. to 290° C.

6. The film of claim 17, further comprising a compatibilizer.

7. The film of claim 17, wherein the chemically incompatible-to-PE polymer comprises polyester and the polyester comprises post-industrial recycled (PIR) polyester or post-consumer recycled (PCR) polyester.

8. A laminated film comprising the film of claim 17, the laminated film further comprising a second film laminated to the film, and wherein the film comprises an exposed surface of the laminated film.

9. The laminated film of claim 8, further comprising a substrate, and wherein the substrate comprises oriented polyester, oriented nylon, or oriented polypropylene.

10. A package comprising the film of claim 17.

11. A laminated film comprising:
a first film comprising a first layer, a second layer, and a third layer with each layer comprising a first surface and an opposing second surface; and
a second film;
wherein the first layer and the third layer comprise polyethylene, wherein the second layer comprises a matrix phase comprising polyethylene in the amount of 75% to 99.5% by weight of the first film and a dispersion phase comprising polyester in the amount of 0.5% to 25% by weight of the first film, wherein the dispersion phase comprises droplets, wherein 90% of the droplets comprise an average length of 0.2 microns to 5.0 microns, wherein the droplets are dispersed in the matrix phase, wherein the first layer, the second layer, and the third layer are coextruded with each other and positioned relative to each other in a sequential order, and wherein the second film is laminated to the first film and comprises an exposed surface of the laminated film.

12. The laminated film of claim 11, wherein the second film is oriented.

13. The laminated film of claim 11, wherein the second film and the first film are laminated by heat, extrusion, or adhesive.

14. The laminated film of claim 11, further comprising printed indicia.

15. The laminated film of claim 11, wherein the polyethylene of the first, second and third layers comprises ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.

16. (canceled)

17. A film comprising:
a matrix phase comprising polyolefin in the amount of 75% to 99.5% by weight of the film; and
a dispersion phase comprising a chemically incompatible-to-PE polymer in the amount of 0.5% to 25% by weight of the film;
wherein the dispersion phase comprises droplets; wherein 90% of the droplets comprise an average length of 0.2 microns to 5.0 microns; and wherein the droplets are dispersed in the matrix phase.

18. The film of claim 17, wherein the matrix phase comprises polyethylene, polypropylene, or combinations thereof.

19. (canceled)

20. A method of making a film comprising:
obtaining a polyethylene film comprising from 10% to 15% of a chemically incompatible-to-PE polymer and 85% to 90% polyethylene by weight;
utilizing a continuous melt filtration pelletizer comprising a filter comprising a plurality of apertures from 5 microns to 150 microns within a temperature range above a melting point of the polyethylene and at least 5% below a melting point of the chemically incompatible-to-PE polymer;
maintaining the continuous melt filtration pelletizer at a pressure below 112 megapascals (MPa);
forming a plurality of pellets, wherein each pellet comprises a dispersed phase comprising the chemically incompatible-to-PE polymer in the amount of less than 25% by weight of the pellet, and wherein the dispersed phase comprises droplets comprising an average length from 0.2 microns to 5.0 microns;
melting the pellets in an extrusion process; and
forming a film that includes a matrix phase comprising polyethylene in the amount of 75% to 99.5% by weight of the film and a dispersion phase comprising the chemically incompatible-to-PE polymer in the amount of 0.5% to 25% by weight of the film;
wherein the dispersion phase comprises droplets; wherein 90% of the droplets comprise an average length of 0.2 microns to 5.0 microns; and wherein the droplets are dispersed in the matrix phase.
